(19) United States
(12) Patent Application Publication
(10) Pub. No.: US 2025/0246728 A1
(43) Pub. Date: Jul. 31, 2025

(54) CYLINDRICAL RECHARGEABLE BATTERY

(71) Applicant: Samsung SDI Co., Ltd., Yongin-si (KR)

(72) Inventors: Dae Kyu Kim, Yongin-si (KR); Kwangsoo Seo, Yongin-si (KR); Jongjun Park, Yongin-si (KR)

(73) Assignee: Samsung SDI Co., Ltd., Yongin-si (KR)

(21) Appl. No.: 18/771,780

(22) Filed: Jul. 12, 2024

(30) Foreign Application Priority Data
Jan. 29, 2024 (KR) 10-2024-0013255

(51) Int. Cl. H01M 50/152; H01M 50/107; H01M 50/159; H01M 50/164; H01M 50/342

(52) U.S. Cl. CPC H01M 50/152; H01M 50/107; H01M 50/159; H01M 50/164; H01M 50/3425; H01M 2200/20

(57) ABSTRACT

A cylindrical rechargeable battery of the present disclosure includes a cylindrical can, an electrode assembly accommodated in the cylindrical can, and a cap assembly coupled to the cylindrical can to seal the electrode assembly, wherein the cap assembly includes a cap-up including a plating layer having an unplated region and a safety vent located below the cap-up and partially bent to surround the unplated region at an edge of the cap-up.

### CROSS-REFERENCE TO RELATED APPLICATIONS

This application claims priority to and the benefit under 35 U.S.C. § 119 (a)-(d) of Korean Patent Application No. 10-2024-0013255 filed at the Korean Intellectual Property Office on Jan. 29, 2024, the entire contents of which are incorporated herein by reference.

### FIELD

The present disclosure relates to a cylindrical rechargeable battery.

### BACKGROUND

Unlike a primary battery, a rechargeable battery may be charged and discharged over and over again. A low-capacity rechargeable battery that includes an electrode assembly packaged in a pack may be used as a power source for various small portable electronic devices such as cellular phones and camcorders, and a high-capacity rechargeable battery that has dozens of connected electrode assemblies may be used as a power source for driving motors such as in an electric scooter, a hybrid automobile, and an electric automobile.

The rechargeable battery may be manufactured in various shapes, among which a cylindrical rechargeable battery may include a cylindrical electrode assembly, a cylindrical can which can accommodate the electrode assembly and electrolyte, and a cap assembly which may be coupled to the top opening of the can to seal the can and allow the current generated in the electrode assembly to flow to an external device.

### SUMMARY

The present disclosure attempts to overcome some issues described herein, and to provide a cylindrical rechargeable battery capable of reducing the plating thickness distribution of a cap-up.

A cylindrical rechargeable battery according to embodiments of the present disclosure for solving some technical issues described herein may include a cylindrical can, an electrode assembly accommodated in the cylindrical can, and a cap assembly coupled to the cylindrical can to seal the electrode assembly, wherein the cap assembly includes a cap-up including a plating layer having an unplated region, and a safety vent located below the cap-up and partially bent to surround the unplated region at an edge of the cap-up.

The plating layer may be formed on a remaining portion of the cap-up excluding a portion of the cap-up at the edge at which the safety vent is bent to surround the unplated region.

The cap-up may include a base part and an inclined part formed to be inclined at a portion of an end of the base part at which the safety vent is bent.

The plating layer may be formed on the remaining portion of the cap-up excluding the inclined part.

The cap-up may include a base part and a round part formed to be rounded at a portion of an end of the base part at which the safety vent is bent.

The plating layer may be formed on the remaining portion of the cap-up excluding the round part.

The base part may be made of iron, and the plating layer may be made of nickel.

The safety vent may include a vent contact part in contact with the cap-up, a vent inclined part inclined downward from the vent contact part, a vent bottom extending parallel from the vent inclined part, and a vent protruding part protruding from the vent bottom.

A method of manufacturing a cylindrical rechargeable battery according to some embodiments of the present disclosure may include a preparation step of preparing a cap-up and a safety vent, a surface treatment step of forming a plating layer by plating the surface of the cap-up in a reel-to-reel manner, an assembly step of bringing the cap-up and the safety vent into close contact, and a safety vent modification step of bending a part of the safety vent corresponding to an edge of the cap-up and bringing the part into close contact with the cap-up.

After the preparation step, a first processing step of processing the edge of the cap-up to be inclined may be further included.

After the preparation step, a second processing step of processing the edge of the cap-up to be rounded may be further included.

A method of manufacturing a cylindrical rechargeable battery according to some embodiments includes preparing a cap-up and a safety vent; forming a plating layer by plating the surface of the cap-up by reel-to-reel plating; bringing the cap-up and the safety vent into close contact with each other; and bending a portion of the safety vent corresponding to an edge of the cap-up and bringing the portion into close contact with the cap-up.

The method may further include after the preparing, processing the edge of the cap-up to be inclined.

The method may further include after the preparing, processing the edge of the cap-up to be rounded.

### BRIEF DESCRIPTION OF THE DRAWINGS

FIG. 1 is a perspective view illustrating a cylindrical rechargeable battery according to some embodiments of the present disclosure.

FIG. 2 is a cross-sectional view illustrating the cylindrical rechargeable battery of FIG. 1.

FIG. 3 is an exploded perspective view illustrating the cylindrical rechargeable battery of FIG. 1.

FIG. 4 is a cross-sectional view illustrating a cap-up and a safety vent of the cylindrical rechargeable battery of FIG. 2.

FIG. 5 is a cross-sectional view illustrating the process of the safety vent being bent and coupling with the cap-up of FIG. 4.

FIG. 6 is a cross-sectional view illustrating a cap-up according to another embodiment.

FIG. 7 is a cross-sectional view illustrating a cap-up according to another embodiment.

FIG. 8 is a flowchart illustrating a method of manufacturing a cylindrical rechargeable battery according to an embodiment of the present disclosure.

FIG. 9 is a flowchart illustrating a method of manufacturing a cylindrical rechargeable battery according to another embodiment of the present disclosure.

FIG. 10 is a flowchart illustrating a method of manufacturing a cylindrical rechargeable battery according to another embodiment of the present disclosure.

### DETAILED DESCRIPTION

The embodiments of the present disclosure further illustrate the present techniques specifically. However, these embodiments are only meant to facilitate understanding for those skilled in the art of the present disclosure and may be embodied in many different forms, so they should not be construed as being limited to the embodiments set forth herein. Rather, these embodiments are provided so that this disclosure will be thorough and complete, and will fully convey the scope of the present inventive concept to those skilled in the art.

In addition, in the accompanying drawings, sizes or thicknesses of various components are exaggerated for brevity and clarity, and like numbers refer to like elements throughout. As used herein, the term “and/or” includes any one and all combinations of one or more of the associated listed items. In addition, it should be understood that when an element A is referred to as being “connected to” an element B, the element A can be directly connected to the element B, or an intervening element C may be present therebetween such that the element A and the element B are indirectly connected to each other.

The terminology used herein is for the purpose of describing example embodiments only and is not intended to be limiting of the disclosure. As used herein, the singular forms are intended to include the plural forms as well, unless the context clearly indicates otherwise. It should be further understood that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It should be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed herein could be termed a second member, a second element, a second region, a second layer and/or a second section without departing from the teachings of the present disclosure.

Spatially relative terms, such as “beneath,” “below,” “lower,” “above,” “upper,” and the like may be used herein for ease of description to describe one element or a feature's relationship to another element(s) or feature(s) as illustrated in the figures. It should be understood that such spatially relative terms are intended to encompass different orientations of the device in use or operation, in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both orientations of above and below.

Hereinafter, a cylindrical rechargeable battery according to embodiments of the present disclosure will be described in detail with reference to the accompanying drawings.

As described herein, the rechargeable battery may be manufactured in various shapes, among which a cylindrical rechargeable battery may include a cylindrical electrode assembly, a cylindrical can which may accommodate the electrode assembly and electrolyte, and a cap assembly. The cap assembly may be coupled to the top opening of the can to seal the can, including the electrode assembly, and allow the current generated in the electrode assembly to flow to an external device.

The cap assembly may include a cap-up, and the cap-up may be subjected to a plating process to prevent corrosion.

However, if the plating layer formed in the cap-up is not uniform and the plating thickness distribution is relatively large, welding defects may occur in the welding process with surrounding members.

The cylindrical rechargeable battery according to the present disclosure may prevent welding defects from occurring by reducing the thickness distribution of electroplating by forming a plating layer on the cap-up in a reel-to-reel manner. Accordingly, the manufacturing defect rate of rechargeable batteries may be reduced, thereby improving productivity and reducing manufacturing costs.

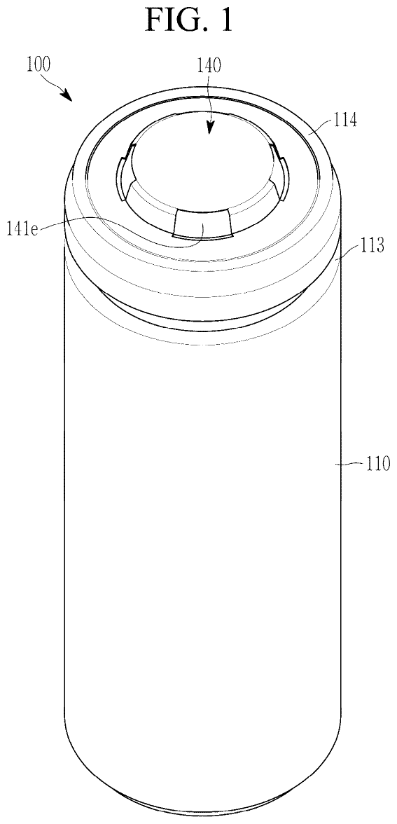

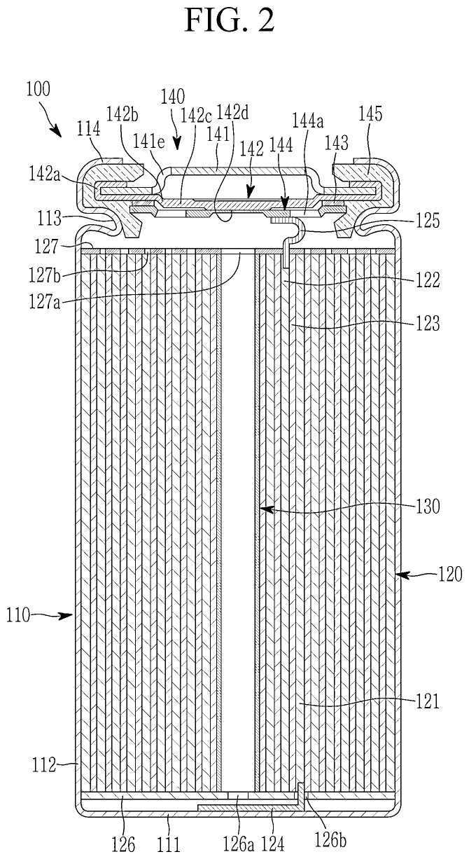

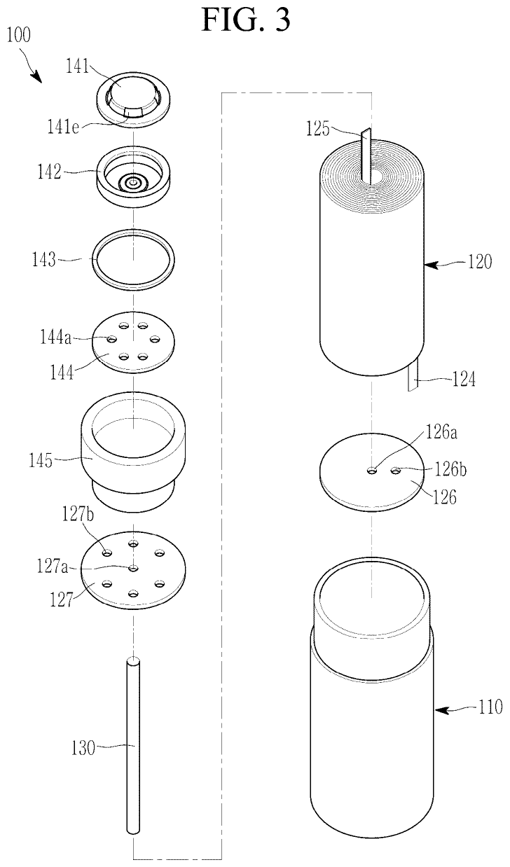

FIG. 1 is a perspective view illustrating a cylindrical rechargeable battery according to some embodiments of the present disclosure. FIG. 2 is a cross-sectional view illustrating the cylindrical rechargeable battery of FIG. 1. FIG. 3 is an exploded perspective view illustrating the cylindrical rechargeable battery of FIG. 1.

As shown in FIGS. 1 to 3, a cylindrical rechargeable battery 100, according to some embodiments of the present disclosure, includes a cylindrical can 110, an electrode assembly 120, and a cap assembly 140.

The cylindrical can 110 may include a circular bottom 111 and a cylindrical side 112 extending from the bottom 111 upward for a predetermined length. During the manufacturing process of the cylindrical rechargeable battery 100, the upper portion of the cylindrical can 110 may be open. Therefore, during the assembly process of the cylindrical rechargeable battery, the electrode assembly 120 may be inserted into the cylindrical can 110 together with the electrolyte solution (e.g., through the opening).

The cylindrical can 110 may include steel, steel alloy, aluminum, aluminum alloy, or equivalents thereof. The cylindrical can 110 may have a beading part 113 recessed inward on the lower portion centered on the cap assembly 140 to prevent the electrode assembly 120 and the cap assembly 140 from being separated to the outside. The cylindrical can 110 may have a crimping part 114 bent inward on the upper portion.

The electrode assembly 120 may be accommodated inside the cylindrical can 110. The electrode assembly 120 may include a negative electrode plate 121 coated with a negative electrode active material (e.g., graphite, carbon), a positive electrode plate 122 coated with a positive electrode active material (e.g., transition metal oxide (LiCoO₂, LiNiO₂, LiMn₂₀₄)), and a separator 123 located between the negative electrode plate 121 and the positive electrode plate 122 such as to prevent short circuiting and only allow movement of lithium ions.

The negative electrode plate 121, the positive electrode plate 122, and the separator 123 may be wound in a substantially cylindrical shape. The negative electrode plate 121 may include copper (Cu) or nickel (Ni) foil, the positive electrode plate 122 may include aluminum (Al) foil, and the separator 123 may include polyethylene (PE) or polypropylene (PP).

A negative electrode tab 124 that may protrude and extend a certain length downward may be welded to the negative electrode plate 121, and a positive electrode tab 125 that may protrude a certain length upward may be welded to the positive electrode plate 122, but the opposite case is also possible. The negative electrode tab 124 may include a copper (Cu) or nickel (Ni) material, and the positive electrode tab 125 may include an aluminum (Al) material.

The negative electrode tab 124 of the electrode assembly 120 may be welded to the bottom 111 of the cylindrical can 110. Therefore, the cylindrical can 110 may operate as a negative electrode. Conversely, the positive electrode tab 125 may be welded to the bottom 111 of the cylindrical can 110, and in this case, the cylindrical can 110 may operate as a positive electrode.

A first insulating plate 126 may be interposed between the electrode assembly 120 and the bottom 111. The first insulating plate 126 may be coupled to the cylindrical can 110, with a first hole 126a in the center and a second hole 126b on the outside (e.g., on an outside portion).

The first insulating plate 126 may prevent the electrode assembly 120 from electrically contacting the bottom 111 of the cylindrical can 110.

The first insulating plate 126 may prevent the positive electrode plate 122 of the electrode assembly 120 from electrically contacting the bottom 111. The first hole 126a may allow gas to quickly move upward through a center pin 130 when a large amount of gas is generated such as due to an abnormality in the cylindrical rechargeable battery. Additionally, the negative electrode tab 124 may be welded to the bottom 111 through the second hole 126b.

A second insulating plate 127 may be interposed between the electrode assembly 120 and the cap assembly 140. The second insulating plate 127 may be coupled to the cylindrical can 110, with a first hole 127a in the center and a plurality of second holes 127b on the outside (e.g., on an outside portion).

The second insulating plate 127 may prevent the electrode assembly 120 from electrically contacting the cap assembly 140. The second insulating plate 127 may limit electrical contact of the negative electrode plate 121 of the electrode assembly 120 to the cap assembly 140.

The first hole 127a may allow gas to quickly move to the cap assembly 140 when a large amount of gas is generated such as due to an abnormality in the cylindrical rechargeable battery. The second hole 127b may allow the positive electrode tab 125 to penetrate and be welded to the cap assembly 140. Additionally, the remaining second holes 127b may allow the electrolyte solution to quickly flow into the electrode assembly 120 during an electrolyte solution injection process.

According to some embodiments, the diameters of each of the first hole 126a of the first insulating plate 126 and the first hole 127a of the second insulating plate 127 may be smaller than the diameter of the center pin 130. Accordingly, the center pin 130 may be prevented from electrically contacting the bottom 111 or the cap assembly 140 of the cylindrical can 110 due to external impact.

The center pin 130 may have the shape of a hollow circular pipe and may be coupled to approximately the center of the electrode assembly 120. The center pin 130 may include steel, steel alloy, aluminum, aluminum alloy, or polybutylene terephthalate.

The center pin 130 may serve to suppress deformation of the electrode assembly 120 during charge and discharge of the battery, and may serve as a movement passage for gas generated inside the cylindrical rechargeable battery. In some cases, the center pin 130 may be omitted.

The cap assembly 140 may include a cap-up 141 having a plurality of through holes 141e, a safety vent 142 located below the cap-up 141, a connecting ring 143 located below the safety vent 142, a plurality of through holes 144a located below the safety vent 142 and the connecting ring 143, and a cap-down 144 electrically connected to the positive electrode tab 125.

The cap-down 144 may be disposed on a bottom side of the cap-up 141 with the safety vent 142 in between. Additionally, the cap assembly 140 may further include an insulating gasket 145.

The insulating gasket 145 may insulate the cap-up 141, the safety vent 142, and the cap-down 144 from a side 112 of the cylindrical can 110. The insulating gasket 145 may be substantially compressed between the beading part 113 and the crimping part 114 included in the side 112 of the cylindrical can 110.

The through hole 141e of the cap-up 141 and the through hole 144a of the cap-down 144 may discharge internal gas to the outside, such as when abnormal internal pressure occurs inside the cylindrical can 110. The internal gas can invert the safety vent 142 upward through the through hole 144a of the cap-down 144, so that the safety vent 142 may be electrically separated from the cap-down 144, and then the safety vent 142 may be torn, allowing the internal gas to be released to the outside through the through hole 141e of the cap-up 141.

An electrolyte solution (not shown in the drawings) may be injected into the inside of the cylindrical can 110, which can allow the lithium ions generated by electrochemical reactions on the negative electrode plate 121 and positive electrode plate 122 inside the battery during charge and discharge.

The electrolyte solution may include a non-aqueous organic electrolyte solution which is a mixture of a lithium salt and a high-purity organic solvent. The electrolyte solution may include a polymer or solid electrolyte using a polymer electrolyte.

Hereinafter, a cap-up included in the cap assembly in a cylindrical rechargeable battery according to embodiments of the present disclosure will be described in detail with reference to the drawings.

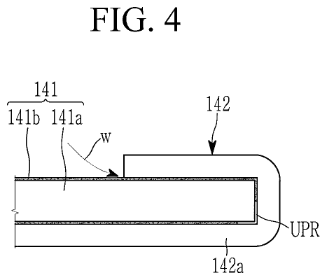

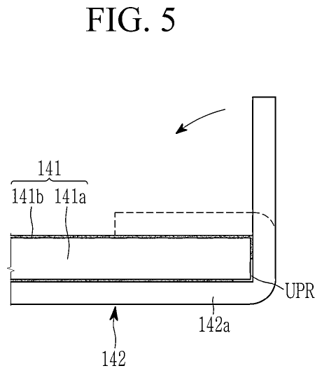

FIG. 3 is an exploded perspective view illustrating the cylindrical rechargeable battery of FIG. 1. FIG. 4 is a cross-sectional view illustrating a cap-up and a safety vent of the cylindrical rechargeable battery of FIG. 2. FIG. 5 is a cross-sectional view illustrating the process of the safety vent being bent and coupling with the cap-up.

Referring to FIGS. 3 to 5, in the cylindrical rechargeable battery 100 according to embodiments of the present disclosure, the cap-up 141 included in the cap assembly 140 includes a plating layer 141b having an unplated region UPR. The plating layer 141b may be uniformly plated on the remaining portion of the cap-up 141 excluding at least a portion thereof. More specifically, the plating layer 141b may not be formed on a portion of the edge of the cap-up 141. The unplated region UPR may be a portion of the cap-up 141 where the plating layer 141b is not formed. The plating layer 141b may be formed in a reel-to-reel manner.

According to some embodiments, the safety vent 142 described above may be located below the cap-up 141, and a portion of the safety vent 142 may be bent to surround the unplated region UPR at the edge of the cap-up 141. That is, the plating layer 141b may be formed on the remaining portion of the cap-up 141 excluding the portion where the safety vent 142 is bent (e.g., at the edge at which the safety vent is bent to surround the unplated region UPR). Additional details of this will be provided later.

In some embodiments, reel-to-reel plating may be used to form the plating layer 141b. Reel-to-reel plating may involve installing a conductive roll on a plating solution and connecting a negative electrode wire of a rectifier to indirectly transfer electrons and charges through the plating solution that is hung on the conductive roll, without directly contacting the plating solution.

Although not shown in the drawings, a reel-to-reel plating device (not shown) for reel-to-reel plating may include a material inlet section that smoothly releases wound material using an uncoiler, a degreasing and pickling unit for cleaning the surface of the material, an ultrasonic wave degreasing unit, and an electrolytic degreasing unit.

In addition, the reel-to-reel plating device may include a pretreatment process part, a main plating unit for main plating (Ni, Ag, Au, etc.) of the material surface, a cleaning unit, and an activation unit. Each processing unit may be configured to be modular and operated independently, allowing for replacement or rearrangement.

Due to the characteristics of the above reel-to-reel plating manner, an unplated region UPR, which is a portion that has not been plated, may be generated in the process of plating the cap-up 141, which is a plating object, using a roll.

In the cylindrical rechargeable battery 100 according to some embodiments of the present disclosure, the unplated region UPR in the cap-up 141 is located in the bent portion of the safety vent 142, and the unplated region UPR is sealed with the safety vent 142, thereby preventing external moisture W from contacting the unplated region UPR.

In addition, the cylindrical rechargeable battery 100 according to the present disclosure may form the plating layer 141b on the cap-up 141 in a reel-to-reel manner, which may thereby reduce the thickness distribution of the plating layer 141b and prevent welding defects. Therefore, by reducing the manufacturing defect rate of rechargeable batteries, it may be possible to improve productivity and reduce manufacturing costs.

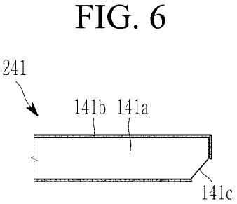

FIG. 6 is a cross-sectional view illustrating a cap-up, according to another example.

Referring to FIG. 6, a cap-up 241 may include a base part 141a and an inclined part 141c as modified examples.

The base part 141a may be the body of the cap-up 241. The base part 141a may be made of iron.

The inclined part 141c may be formed to be inclined at a portion of an end of the base part 141a where the safety vent 142 is bent (e.g., as described in relation to FIG. 5). More preferably, the inclined part 141c may be located below the end of the base part 141a based on the direction shown in the drawings.

If the cap-up 241 does not include the inclined part 141c, unplated regions may be formed irregularly during reel-to-reel plating to form the plating layer 141b. However, in the cylindrical rechargeable battery 100 according to an embodiment of the present disclosure, the inclined part 141c may be formed on the cap-up 241 before plating is performed, so that the plating layer 141b may be uniformly formed on the remaining portion excluding the inclined part 141c, and the plating layer 141b may not be substantially formed on the inclined part 141c.

In the manufacturing process of the cylindrical rechargeable battery 100 according to some embodiments of the present disclosure, a portion of the safety vent 142 may be bent so that the safety vent 142 surrounds the end of the base part 141a. In this case, the plating layer 141b may be formed on the remaining portion of the cap-up 241 excluding the inclined part 141c. Accordingly, the safety vent 142 may block external moisture (e.g., W, described in relation to FIG. 4) from flowing into the unplated region.

In addition, compared to the cap-up 141 (e.g., as shown in FIG. 5) which does not include the inclined part 141c, the inclined part 141c may more easily adhere to the bent portion of the safety vent 142 without separation. Therefore, in some embodiments, the cap-up 241 including the inclined part 141c may be more advantageous in preventing the inflow of the moisture (e.g., W, described in relation to FIG. 4) from the outside compared to the cap-up 141 (e.g., as shown in FIG. 5) which does not include the inclined part 141c.

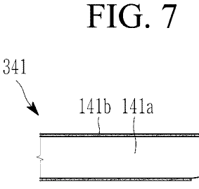

FIG. 7 is a cross-sectional view illustrating a cap-up according to another embodiment.

Referring to FIG. 7, a cap-up 341 may include the base part 141a and a round part 141d, as another modified example.

The base part 141a may be the body of the cap-up 341. Since the base part 141a has been described above, detailed description thereof will be omitted here for simplicity.

The round part 141d may be formed to be round at a portion of an end of the base part 141a where the safety vent 142 is bent (e.g., as described in relation to FIG. 5). More preferably, the round part 141d may be formed below the end of the base part 141a based on the direction shown in the drawings.

The plating layer 141b may be formed on the remaining portion of the cap-up 341 excluding the round part 141d. Accordingly, as in the above-described embodiment, the safety vent 142 may block external moisture (e.g., W, described in relation to FIG. 4) from flowing into the unplated region. The plating layer 141b may be made of nickel.

In some embodiments, when compared to the above-described inclined part 141c, the round part 141d may easily adhere to the bent portion of the safety vent 142 without separation. Therefore, the cap-up 341 including the round part 141d may be more advantageous, in some examples, than the cap-up 241 including the inclined part 141c (e.g., as shown in FIG. 6) in preventing the inflow of moisture (e.g., W, described in relation to FIG. 4).

In some embodiments, the above-described safety vent 142 may include, for example, a vent contact part 142a in contact with the cap-up 141, a vent inclined part 142b inclined downward from the vent contact part 142a, a vent bottom 142c extending parallel from the vent inclined part 142b, and vent protruding part 142d protruding from the vent bottom 142c and contacting (connecting or engaging) the cap-down 144.

Here, the vent contact part 142a may be bent multiple times to contact the lower, side, and upper surfaces of the cap-up 141, respectively. Since the safety vent 142 has been described above, detailed description thereof will be omitted for simplicity.

Hereinafter, a method of manufacturing a cylindrical rechargeable battery, such as for manufacturing the above-described cylindrical rechargeable battery 100 (e.g., as shown in FIG. 1), will be described with reference to the drawings.

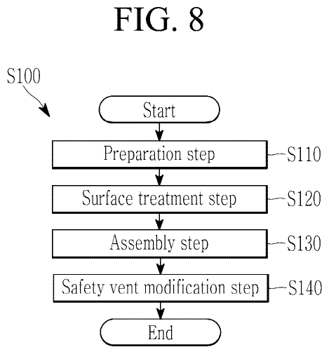

FIG. 8 is a flowchart illustrating a method of manufacturing a cylindrical rechargeable battery, according to an embodiment of the present disclosure.

Referring to FIG. 8, the cylindrical rechargeable battery manufacturing method (S100) according to an embodiment of the present techniques includes a preparation step (S110), a surface treatment step (S120), an assembly step (S130), and a safety vent modification step (S140).

In the preparation step (S110), a cap-up and safety vent may be prepared. The cap-up and the safety vent may be manufactured separately.

In the surface treatment step (S120), a plating layer may be formed by plating the surface of the cap-up in a reel-to-reel manner. The surface treatment step (S120) may be a plating process, and the reel-to-reel plating described herein may be performed. In some embodiments, the reel-to-reel plating may involve installing a conductive roll on a plating solution and connecting a negative electrode wire of a rectifier to indirectly transfer electrons and charges through the plating solution that is caught on the roll without directly contacting the plating solution. Accordingly, some unplated regions may be formed at the edges of the cap-up, and a plating layer may be formed uniformly in the remaining regions.

In the assembly step (S130), the cap-up and the safety vent may be brought into close contact (e.g., with each other). The assembly step (S130) may be a step of assembling each component included in the cylindrical rechargeable battery, and a detailed description of the assembly process of the remaining components excluding the cap-up and safety vent will be omitted for simplicity.

In the safety vent modification step (S140), the portion of the safety vent corresponding to an edge of the cap-up may be bent and brought into close contact with the cap-up. In some cases, it may be advantageous for the bent portion of the safety valve to fit closely with the cap-up with as little clearance as possible to prevent moisture from entering.

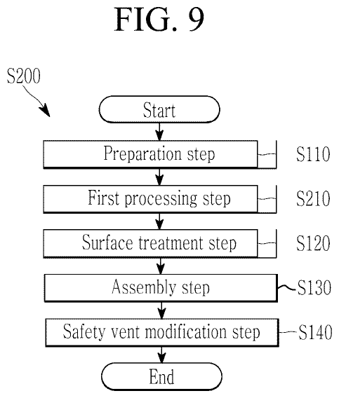

FIG. 9 is a flowchart illustrating a method of manufacturing a cylindrical rechargeable battery according to another embodiment of the present disclosure.

Referring to FIG. 9, the cylindrical rechargeable battery manufacturing method (S200) according to another embodiment of the present disclosure may further include a first processing step (S210) after the preparation step (S110).

In the first processing step (S210), the edge of the cap-up may be processed to be inclined. Accordingly, the above-described inclined part (e.g., as described in relation to FIG. 6) may be formed along the edge of the cap-up. Since the inclined part has been described above, detailed description thereof will be omitted for simplicity.

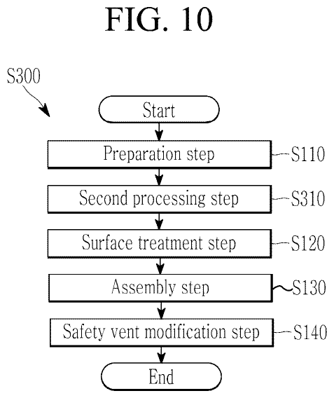

FIG. 10 is a flowchart illustrating a method of manufacturing a cylindrical rechargeable battery according to another embodiment of the present disclosure.

Referring to FIG. 10, the method of manufacturing the cylindrical rechargeable battery (S300) according to another embodiment of the present disclosure may further include a second processing step (S310) after the preparation step (S110).

In the second processing step (S310), the edge of the cap-up may be processed to be round. Accordingly, the above-described round part may be formed along the edge of the cap-up (e.g., as described in relation to FIG. 7). Since the round part has been described above, detailed description thereof will be omitted for simplicity.

As described above, the cylindrical rechargeable battery manufacturing method (S100) according to an embodiment of the present disclosure may prevent welding defects by reducing the thickness dispersion of the electrolytic plating layer by forming the plating layer on the cap-up in a reel-to-reel manner, unlike a method of manufacturing a cylindrical secondary battery that plates the cap-up using a conventional plating method.

According to some embodiments, there is provided a method of manufacturing a cylindrical rechargeable battery, the method including: preparing a cap-up and a safety vent, forming a plating layer by plating the surface of the cap-up by reel-to-reel plating, bringing the cap-up and the safety vent into close contact with each other, and bending a portion of the safety vent corresponding to an edge of the cap-up and bringing the portion into close contact with the cap-up.

According to some embodiments, the method may include after preparing the cap-up and the safety vent, processing an edge of the cap-up to be inclined.

According to some embodiments, the method may include after preparing the cap-up and the safety vent, processing the edge of the cap-up to be rounded.

While this disclosure has been described in connection with what is presently considered to be practical exemplary embodiments, the drawings and the detailed description of the present disclosure which are described above are merely illustrative, are just used for the purpose of describing the present techniques, and are not used for qualifying the meaning or limiting the scope of the present disclosure, which is disclosed in the appended claims. Therefore, it should be understood by those skilled in the art that various modifications and other equivalent embodiments may be made from the present disclosure. Accordingly, a technical protection scope of the present disclosure is to be defined by the claims.

What is claimed is:

1. A cylindrical rechargeable battery, comprising:
a cylindrical can;
an electrode assembly accommodated in the cylindrical can; and
a cap assembly coupled to the cylindrical can and sealing the electrode assembly,
wherein the cap assembly comprises:
a cap-up including a plating layer having an unplated region; and
a safety vent located below the cap-up and partially bent to surround the unplated region at an edge of the cap-up.

2. The cylindrical rechargeable battery as claimed in claim 1, wherein the plating layer is formed on a remaining portion of the cap-up excluding a portion of the cap-up at the edge at which the safety vent is bent to surround the unplated region.

3. The cylindrical rechargeable battery as claimed in claim 1, wherein the cap-up comprises:
a base part; and
an inclined part formed to be inclined at a portion of an end of the base part at which the safety vent is bent.

4. The cylindrical rechargeable battery as claimed in claim 3, wherein the plating layer is formed on a remaining portion of the cap-up excluding the inclined part.

5. The cylindrical rechargeable battery as claimed in claim 3, wherein the base part is made of iron and the plating layer is made of nickel.

6. The cylindrical rechargeable battery as claimed in claim 1, wherein the cap-up comprises:
a base part; and
a round part formed to be round at a portion of an end of the base part at which the safety vent is bent.

7. The cylindrical rechargeable battery as claimed in claim 6, wherein the plating layer is formed on a remaining portion of the cap-up excluding the round part.

8. The cylindrical rechargeable battery as claimed in claim 6, wherein the base part is made of iron and the plating layer is made of nickel.

9. The cylindrical rechargeable battery as claimed in claim 1, wherein the safety vent comprises:
a vent contact part in contact with the cap-up;
a vent inclined part inclined downward from the vent contact part;
a vent bottom extending parallel from the vent inclined part; and
a vent protruding part protruding from the vent bottom.

10. A method of manufacturing a cylindrical rechargeable battery, the method comprising:
a preparation step of preparing a cap-up and a safety vent;
a surface treatment step of forming a plating layer by plating the surface of the cap-up in a reel-to-reel manner;
an assembly step of bringing the cap-up and the safety vent into close contact with each other; and
a safety vent modification step of bending a portion of the safety vent corresponding to an edge of the cap-up and bringing the portion into close contact with the cap-up.

11. The method of manufacturing the cylindrical rechargeable battery as claimed in claim 10, wherein after the preparation step,
a first processing step of processing the edge of the cap-up to be inclined is further included.

12. The method of manufacturing the cylindrical rechargeable battery as claimed in claim 10, wherein after the preparation step,
a second processing step of processing the edge of the cap-up to be rounded is further included.

13. A method of manufacturing a cylindrical rechargeable battery, the method comprising:
preparing a cap-up and a safety vent;
forming a plating layer by plating the surface of the cap-up by reel-to-reel plating;
bringing the cap-up and the safety vent into close contact with each other; and
bending a portion of the safety vent corresponding to an edge of the cap-up and bringing the portion into close contact with the cap-up.

14. The method of manufacturing the cylindrical rechargeable battery as claimed in claim 13, further comprising after the preparing, processing the edge of the cap-up to be inclined.

15. The method of manufacturing the cylindrical rechargeable battery as claimed in claim 13, further comprising after the preparing, processing the edge of the cap-up to be rounded.
